(19) United States
(12) Patent Application Publication
(10) Pub. No.: US 2015/0061571 A1
(43) Pub. Date: Mar. 5, 2015

(54) STORING AND CHARGING APPARATUS

(71) Applicant: Chung Chiao Holding Corp, Taipei City (TW)

(72) Inventor: Sung-Ching LIN, Taoyuan County (TW)

(73) Assignee: Chung Chioa Holding Corp., Taipei City (TW)

(21) Appl. No.: 14/013,537

(22) Filed: Aug. 29, 2013

(51) Int. Cl. H02J 7/00

(52) U.S. Cl. CPC H02J 7/0044
USPC 320/107

(57) ABSTRACT

A storing and charging apparatus includes a housing including two storage racks mounted in an accommodation chamber therein and respectively defining a plurality of vertically spaced storage compartments for storing mobile electronic devices, a partition panel set in between the two storage racks to hold a plurality of connection ports, two U-shaped sliding tracks disposed at two opposite lateral sides of the accommodation chamber and an access opening, a sliding door coupled to and movable along the U-shaped sliding tracks to close/open an access opening, and a power module mounted in a rear side in the accommodation chamber of the housing.

### BACKGROUND OF THE INVENTION

1. Field of the Invention

The present invention relates to storage means for use in a desk or the like for storing mobile electronic devices, and more particularly to a storing and charging apparatus, which can store multiple mobile electronic devices and charge the batteries of the storage mobile electronic devices synchronously.

2. Description of the Related Art

With fast development of electronic and multimedia technologies, advanced and sophisticated notebook computers, tablet computers, smart phones, PDAs and many other mobile electronic devices have been continuously created and appeared on the market. These mobile electronic devices have the characteristics of small size, light weight and high mobility. With continuous creation of hardware and software functions, mobile electronic devices are widely used in our daily life for different purposes.

However, due to the characteristics of small size, light weight and high mobility, these mobile electronic devices can easily be damaged by impact. Protective cases are commercially available for protecting mobile electronic devices. However, these commercial protective cases are commonly designed for storing an individual mobile electronic device. Further, a school, organization or office may need to use a large number of tablet computers, notebook computers, PDAs or other mobile electronic devices to satisfy different requirements for information sorting or different software applications. After use, these mobile electronic devices may be directly left on desks. The use of a large amount of mobile electronic devices brings inconvenience to the person in charge. Further, these mobile electronic devices can be easily stolen.

Further, putting mobile electronic devices in protective cases facilitates carrying and enhancing convenience and ease of use. However, conventional protective cases for mobile electronic device do not provide a charging function. When going to charge each storage mobile electronic device, the user must take the storage mobile electronic device out of the protective case and then electrically connect the mobile electronic device to an external power source by a power adapter or battery charger. Further, when a user wishes to update the educational software program or other application software program of multiple mobile electronic devices, the user must connect every mobile electronic device individually to a host computer or server and start every mobile electronic device, and then control the host computer or server to update the software program. However, this individual mobile electronic device updating operation takes much time. It is quite inconvenient to connect and arrange the transmission cables of a large amount of mobile electronic devices.

### SUMMARY OF THE INVENTION

The present invention has been accomplished under the circumstances in view. It is the main object of the present invention to provide a storing and charging apparatus, which is practical for storing multiple mobile electronic devices and charging them synchronously. It is another object of the present invention to provide a storing and charging apparatus, which creates an optimal spatial arrangement, facilitating storage of a large amount of mobile electronic devices. It is still another object of the present invention to provide a storing and charging apparatus, which keeps the cables of storage mobile electronic devices well organized, avoiding tangled cables. It is still another object of the present invention to provide a storing and charging apparatus, which facilitates quick heat dissipation during charging or synchronous data transmission of storage mobile electronic devices. It is still another object of the present invention to provide a storing and charging apparatus, which allows multiple storing and charging apparatuses be conveniently arranged in a stack.

To achieve these and other objects of the present invention, a storing and charging apparatus of the invention comprises a housing, which comprises an accommodation chamber, an access opening in communication with the accommodation chamber, two substantially U-shaped sliding tracks at two opposite lateral sides of the accommodation chamber, two storage racks mounted in the accommodation chamber in a parallel manner and respectively defining therein a plurality of vertically spaced storage compartments for storing mobile electronic devices individually and a partition panel vertically set between the two storage racks and holding a plurality of connection ports, a sliding door coupled to the U-shaped sliding tracks and movable along the U-shaped sliding tracks to close/open the access opening, and a power module mounted in the accommodation chamber of the housing at a back side relative to the partition panel.

Preferably, the housing further comprises a plurality of wire-organizer brackets transversely affixed to the front wall of the partition panel at different elevations for organizing the cables of storage mobile electronic devices. Each wire-organizer bracket comprises a plurality of wire grooves horizontally arranged in a line at a bottom side thereof, a plurality of retaining notches horizontally arranged in a line at an opposing top side thereof and a wire entry defined in a front side of each said retaining notch corresponding to one respective said wire groove. Further, the wire entries of each wire-organizer bracket define different widths for organizing cables of different diameters.

Preferably, the housing further comprises an internal electric fan mounted in the power module inside the housing and adapted for expelling hot air from the inside of the housing to the surroundings, an external electric fan mounted in an outside wall of the housing at a rear side relative to the power module and aimed at the first electric fan, and a plurality of ventilation holes disposed corresponding to the external electric fan.

Preferably, the housing further comprises a plurality of hanging holes located at a back side thereof for hanging on a wall.

Preferably, the housing further comprises a plurality of mating mounting grooves and mounting ribs symmetrically located at opposing top and bottom sides thereof. By means of fastening the mounting grooves or mounting ribs of one storing and charging apparatus to the mounting ribs or mounting grooves of another storing and charging apparatus, multiple storing and charging apparatuses can be fastened together in a stack.

Preferably, the front bar of the sliding door comprises two coupling rods respectively extended from two distal ends thereof and respectively slidably coupled to the U-shaped sliding tracks of the housing, two sloping guide surfaces respectively disposed at the two distal ends at a front side relative to the coupling rods, at least one pivot member located at a rear side thereof and a grip. Preferably, each sliding door slat of the sliding door comprises a flexible slat body slidably coupled between the U-shaped sliding tracks of the housing, a plurality of slat components extended from the flexible slat body and defining therein an open-ended space, at least one pivot member, and at least one knuckle member. The at least one knuckle member of each sliding door slat is pivotally coupled to the at least one pivot member of the front bar or the at least one pivot member of another sliding door slat.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational front view of a storing and charging apparatus in accordance with the present invention.

FIG. 2 is an oblique bottom elevational rear side view of the storing and charging apparatus in accordance with the present invention.

FIG. 3 is an exploded view of the storing and charging apparatus in accordance with the present invention.

FIG. 4 corresponds to FIG. 3 when viewed from another angle.

FIG. 5 is an enlarged view the wire-organizer bracket of the storing and charging apparatus in accordance with the present invention.

FIG. 6 is a partial enlarged view of the sliding door of the storing and charging apparatus in accordance with the present invention

FIG. 7 is a schematic applied view of the present invention, illustrating mobile electronic devices stored in the compartments of the storage racks.

FIG. 8 is an oblique top elevational front view of the present invention, illustrating the sliding door of the storing and charging apparatus closed.

FIG. 9 illustrates two storing and charging apparatuses arranged in a stack in accordance with the present invention.

### DETAILED DESCRIPTION OF THE PREFERRED EMBODIMENT

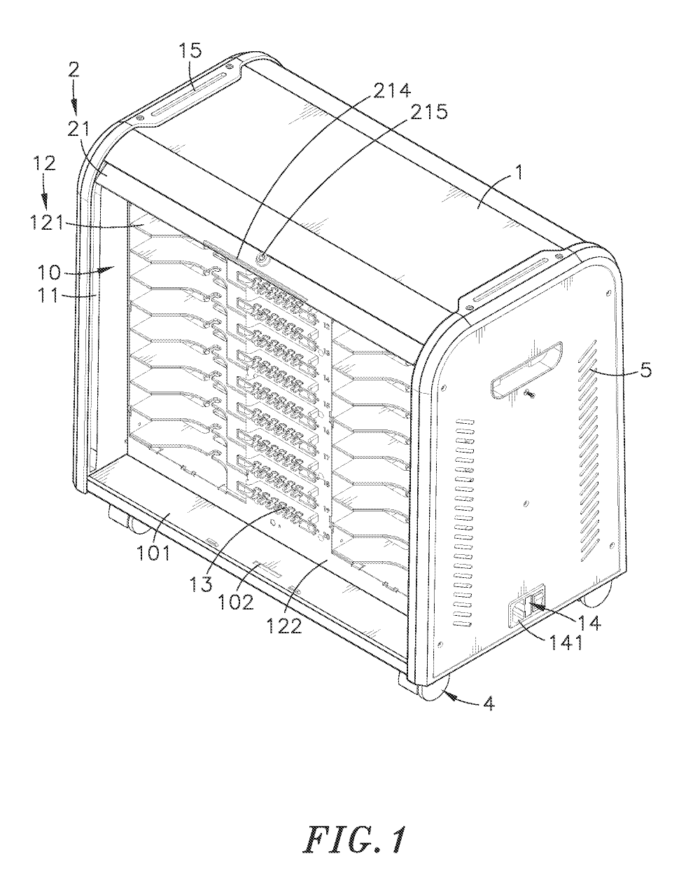

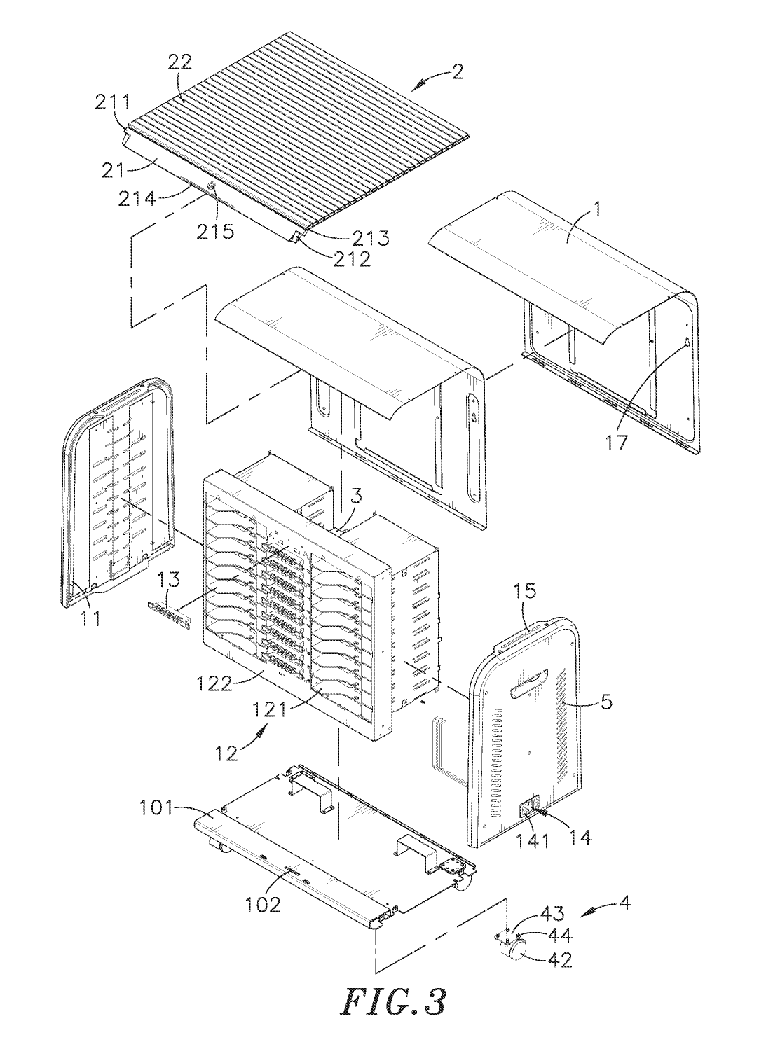

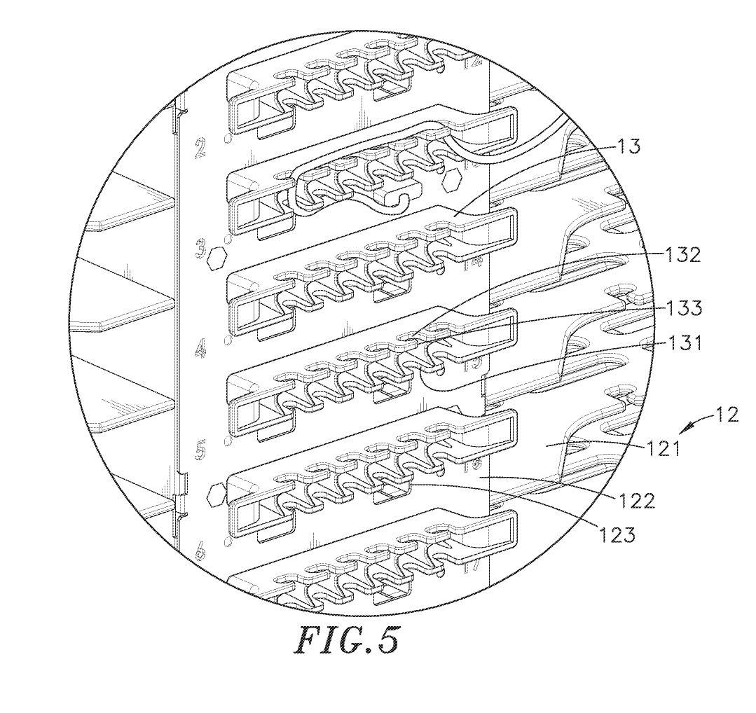

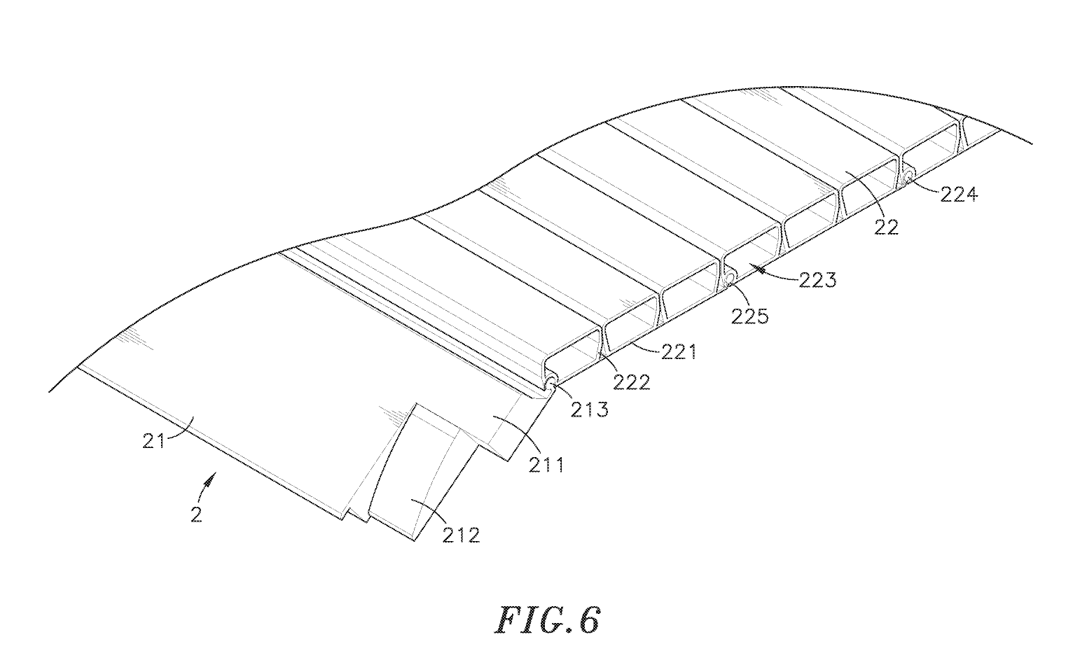

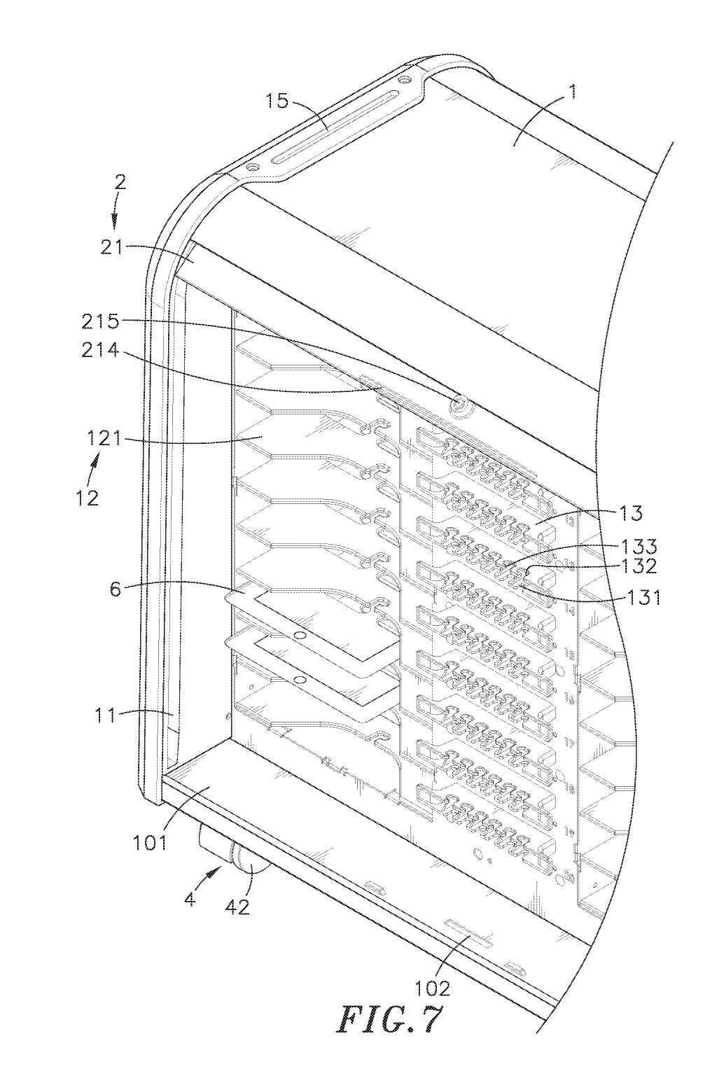

Referring to FIGS. 1-7, a storing and charging apparatus in accordance with the present invention is shown. The storing and charging apparatus comprises a housing 1, a sliding door 2, a power module 3, and a wheel set 4.

The housing 1 comprises an accommodation chamber 10, an access opening 101 disposed at a front side thereof in communication with the accommodation chamber 10, a lock hole 102 disposed in a bottom side of the access opening 101, two substantially U-shaped sliding tracks 11 respectively upwardly extended from two distal ends of the bottom side of the access opening 101 to two distal ends of an opposing top side of the access opening 101 and then horizontally backwardly extended from the two distal ends of the top side of the access opening 101 along two opposite top lateral sides of the accommodation chamber 10 to two distal ends of a rear top side of the accommodation chamber 10 and then vertically downwardly extended from the two distal ends of the rear top side of the accommodation chamber 10 to two distal ends of a rear bottom side of the accommodation chamber 10, two storage racks 12 mounted in the accommodation chamber 10 in a parallel manner each defining therein a plurality of storage compartments 121, a partition panel 122 vertically mounted in between the two storage racks 12 at a front side, a plurality of connection ports 123 installed in the partition panel 122 at different elevations, a plurality of wire-organizer brackets 13 transversely affixed to the front wall of the partition panel 122 at different elevations, a power switch 14 mounted in one outside wall thereof for power on/off control, a power socket 141 disposed adjacent to the power switch 14 for connecting to an external power source by a power cable (not shown), a plurality of mating mounting grooves 15 and mounting ribs 16 symmetrically located at opposing top and bottom sides thereof, a plurality of hanging holes 17 located at a back side thereof, and a connection module 18 mounted in another outside wall thereof. Further, each wire-organizer bracket 13 comprises a plurality of wire grooves 131 horizontally arranged in a line at a bottom side thereof, a plurality of retaining notches 132 horizontally arranged in a line at an opposing top side thereof, and a wire entry 133 defined in a front side of each of the retaining notches 132 corresponding to one respective wire groove 131. Further, the connection module 18 comprises at least one electrical connector 181.

The sliding door 2 is coupled to the U-shaped sliding tracks 11 of the housing 1 and movable along the U-shaped sliding tracks 11 to close/open the access opening 101, comprising a transversely extending front bar 21 and a plurality of sliding door slats 22. The front bar 21 comprises two coupling rods 211 respectively extended from two distal ends thereof and respectively slidably coupled to the U-shaped sliding tracks 11 of the housing 1, two sloping guide surfaces 212 respectively disposed at the two distal ends at a front side relative to the coupling rods 211, at least one pivot member 213 located at a rear side thereof, a grip 214 located at an opposing front side thereof, and a lock 215 disposed adjacent to the grip 214 and lockable to the lock hole 102. Further, each sliding door slat 22 comprises a flexible slat body 221 slidably coupled between the U-shaped sliding tracks 11 of the housing 1, a plurality of slat components 222 extended from the flexible slat body 221 and defining therein an open-ended space 223, at least one pivot member 224, and at least one knuckle member 225. By means of pivotally connecting the at least one knuckle member 225 of each sliding door slat 22 to the at least one pivot member 213 of the front bar 21 or the at least one pivot member 224 of another sliding door slat 22, the front bar 21 and the sliding door slats 22 are coupled together.

The power module 3 is mounted in the accommodation chamber 10 of the housing 1 at a back side relative to the partition panel 122, and electrically connected to the power switch 14 and the power socket 141. Further, an internal electric fan 31 is mounted in the power module 3 inside the housing 1 and adapted for expelling hot air from the inside of the housing 1 to the surroundings. Further, an external electric fan 32 is mounted in the housing 1 behind the power module 3 and aimed at the first electric fan 31 for enhancing heat dissipation.

The wheel set 4 comprises at least three, for example, four mounting plates 43 respectively affixed to a bottom wall of the housing 1 in four corners by screws 44, a wheel bracket 41 mounted in each mounting plate 43, and a wheel 42 pivotally mounted in each wheel bracket 41.

During application of the storing and charging apparatus, mobile electronic devices 6 can be selectively stored in the storage compartments 121 of the two storage racks 12 in the accommodation chamber 10 of the housing, and then electrically connected the cables (not shown) of the mobile electronic devices 6 to the connection ports 123 in the partition panel 122 between the two storage racks 12 respectively for synchronous data transmission or battery charging.

Further, after insertion of mobile electronic devices 6 into selected storage compartments 121 of the storage racks 12, the user can selectively insert the cables of the storage mobile electronic devices 6 into the wire entries 133 of the wire-organizer brackets 13 at the front wall of the partition panel 122, and then wind the cables round the respective wire grooves 131 and retaining notches 132, and then electrically connect the cables to the adjacent connection ports 123. Thus, the cables of the storage mobile electronic devices 6 are well organized, avoiding tangled cables. Further, the wire entries 133 of each wire-organizer bracket 13 have different widths for organizing cables of different diameters to widen the applicability of the wire-organizer brackets 13.

Referring to FIGS. 1-4 again, as stated above, the power module 3 is mounted in the accommodation chamber 10 of the housing 1 behind the partition panel 122. During operation of the power module 3, the internal electric fan 31 is simultaneously driven to expel hot air from the accommodation chamber 10 to the outside of the housing 1, and the external electric fan 32 is also driven to enhance heat dissipation, thereby lowering the temperature of the power module 3.

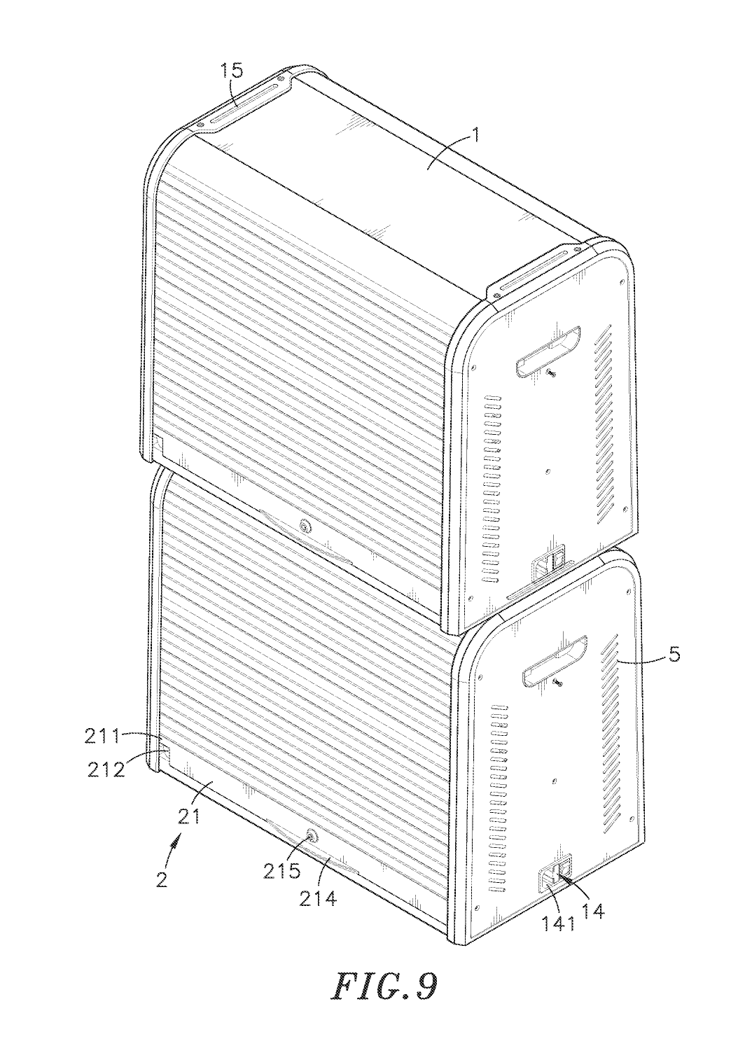

Referring to FIG. 9 and FIGS. 1-4 again, by means of the wheels 42 of the wheel set 4, the user can move the storing and charging apparatus on the table or floor to the desired location conveniently. Further, by means of dismounting the screws 44 from the mounting plates 43 and the bottom wall of the housing 1, the wheel brackets 41, wheels 42 and mounting plates 43 of the wheel set 4 can be detached from the housing 1. At this time, the user can use the hanging holes 17 to hang the storing and charging apparatus on a wall (not shown). Further, the invention allows multiple storing and charging apparatuses to be arranged in a stack by engaging the mounting ribs 16 of one storing and charging apparatus into the mounting grooves 15 of another storing and charging apparatus.

Further, in one example of the present invention, one or multiple mounting grooves 15 are disposed at the top wall of the housing 1, and one or multiple mounting ribs 16 are disposed at the bottom wall of the housing 1. In another example of the present invention, one or multiple mounting grooves 15 are disposed at the bottom wall of the housing 1, and one or multiple mounting ribs 16 are disposed at the top wall of the housing 1. In still another example of the present invention, the housing 1 comprises at least one mounting groove 15 and at least one mounting rib 16 at the top wall thereof, and at least one mounting rib 16 and at least one mounting groove 15 at the bottom wall thereof, wherein each mounting groove 15 at the top wall is disposed corresponding to one respective mounting rib 16 at the bottom wall; each mounting rib 16 at the top wall is disposed corresponding to one respective mounting groove 15 at the bottom wall.

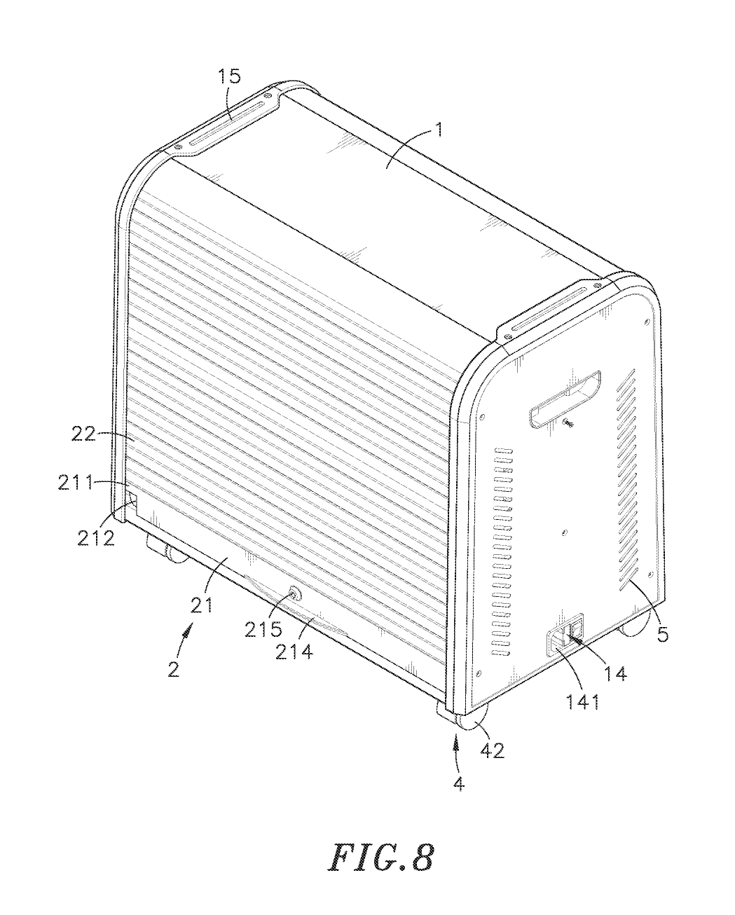

Referring to FIG. 8 and FIGS. 1-7 again, the sliding door 2 can be moved along the U-shaped sliding tracks 11 to close/open the access opening 101 of the housing 1. As stated above, two coupling rods 211 of the front bar 21 are respectively slidably coupled to the U-shaped sliding tracks 11 of the housing 1, and the sliding door slats 22 are hinged to one another and to the front bar 21 and slidably coupled to the U-shaped sliding tracks 11. If the user wishes to open the sliding door 2, unlock the lock 215 from the lock hole 102, and then pull the grip 214 of the front bar 21 to move the front bar 21 upwardly along the U-shaped sliding tracks 11 to the top side of the access opening 101 and then push the front bar 21 horizontally backwardly along two opposite top lateral sides of the accommodation chamber 10 toward the rear top side of the accommodation chamber 10 to move the sliding door slats 22 to the rear side of the accommodation chamber 10. If the user wishes to close the sliding door 2, pull the grip 214 of the front bar 21 forwardly and then downwardly along the U-shaped sliding tracks 11 to the bottom side of the access opening 101, and then lock the lock 215 to the lock hole 102.

As stated above, the U-shaped sliding tracks 11 respectively upwardly extend from two distal ends of the bottom side of the access opening 101 to two distal ends of an opposing top side of the access opening 101 and then horizontally backwardly extend along two opposite top lateral sides of the accommodation chamber 10 to two distal ends of a rear top side of the accommodation chamber 10 and then vertically downwardly extend to two distal ends of the rear bottom side of the accommodation chamber 10. Further, the sliding door slats 22 are flexible, and the slat components 222 are elastically compressible. By means of pivotally connecting the at least one knuckle member 225 of each sliding door slat 22 to the at least one pivot member 213 of the front bar 21 or the at least one pivot member 224 of another sliding door slat 22, the front bar 21 and the sliding door slats 22 are coupled together. When moving the front bar 21 and the sliding door slats 22 through curved areas of the U-shaped sliding tracks 11, the sliding door slats 33 can be elastically compressed, facilitating moving the sliding door 2 between the close position and the open position.

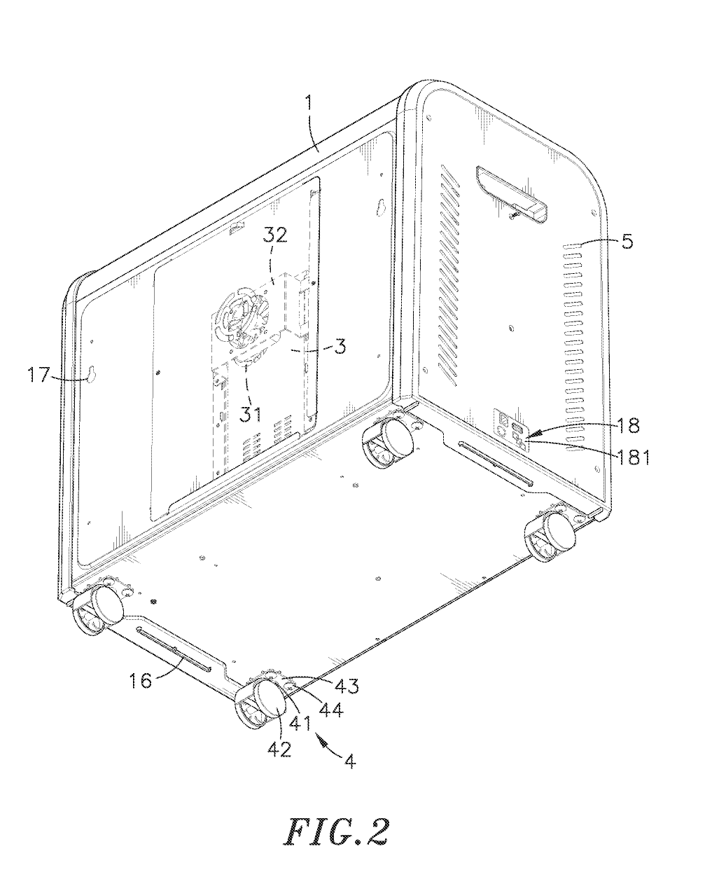

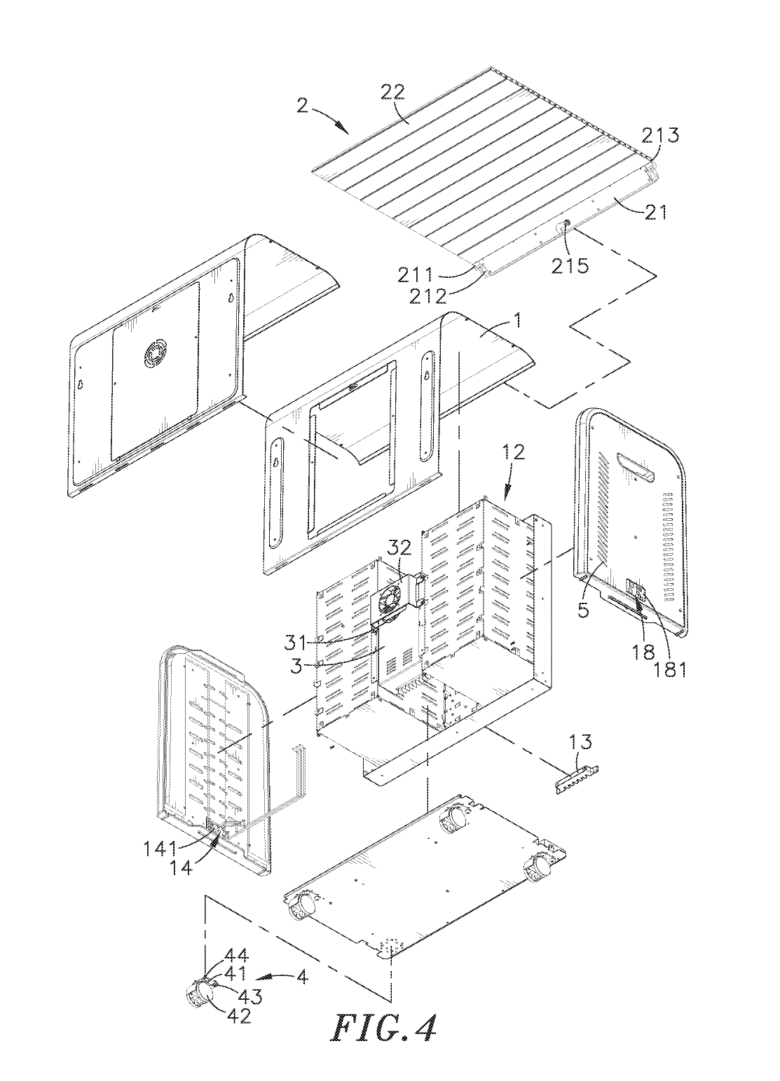

Referring to FIGS. 2 and 4 again, the electrical connectors 181 of the connection module 18 can be USB connectors, fiber optic connectors, SATA connectors, or thunderbolt connectors. Electrical charging devices and computers can be electrically connected in series to the electrical connectors 181 for data transmission or control operation.

Referring to FIGS. 1-4 again, ventilation holes 5 can be made in lateral walls of the housing 1 and lateral walls of the storage racks 12 in air communication with the accommodation chamber 10 for ventilation. During synchronous data transmission or battery charging of multiple storage electronic devices 6, the ventilation holes 5 facilitate quick heat dissipation. Ventilation holes 5 can also be made in opposing front and rear walls of the power module 3 corresponding to the internal electric fan 31 and the external electric fan 32 to facilitate quick heat dissipation.

In conclusion, the invention provides a storage and charging apparatus, which comprises a housing, which comprises an accommodation chamber defined therein, an access opening disposed at a front side thereof in communication with the accommodation chamber and two storage racks arranged in parallel in the accommodation chamber and defining therein a plurality of vertically spaced compartments for storing mobile electronic devices, a sliding door coupled to the housing and movable to close/open the access opening of the housing, a power module mounted in the accommodation chamber behind the storage racks, and a wheel set detachably mounted at the bottom side of the housing to facilitate moving the storage and charging apparatus. Further, mating mounting grooves and mounting ribs are provided at opposing top and bottom walls of the housing so that multiple storage and charging apparatuses can be fastened to one another in a stack.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A storing and charging apparatus, comprising:
a housing comprising an accommodation chamber defined therein, an access opening disposed at a front side thereof in communication with said accommodation chamber, two substantially U-shaped sliding tracks symmetrically disposed in said accommodation chamber at two opposite lateral sides, two storage racks mounted in said accommodation chamber in a parallel manner, each said storage rack defining therein a plurality of storage compartments for storing mobile electronic devices individually, and a partition panel vertically mounted in between said two storage racks at a front side;
a sliding door coupled to said U-shaped sliding tracks of said housing and movable along said U-shaped sliding tracks to close/open said access opening; and
a power module mounted in said accommodation chamber of said housing at a back side relative to said partition panel.

2. The storing and charging apparatus as claimed in claim 1, wherein said housing further comprises a lock hole disposed in a bottom side of said access opening; said sliding door comprises a transversely extending front bar and a plurality of sliding door slats hinged to one another and to said front bar, said front bar comprising a lock lockable to said lock hole of said housing.

3. The storing and charging apparatus as claimed in claim 1, wherein said substantially U-shaped sliding tracks of said housing respectively upwardly extended from two distal ends of the bottom side of said access opening to two distal ends of an opposing top side of said access opening and then horizontally backwardly extend from the two distal ends of the top side of said access opening along two opposite top lateral sides of said accommodation chamber to two distal ends of a rear top side of said accommodation chamber and then vertically downwardly extend from the two distal ends of the rear top side of said accommodation chamber to two distal ends of a rear bottom side of said accommodation chamber.

4. The storing and charging apparatus as claimed in claim 1, wherein said housing further comprises a plurality of wire-organizer brackets transversely affixed to a front wall of said partition panel at different elevations, each said wire-organizer bracket comprising a plurality of wire grooves horizontally arranged in a line at a bottom side thereof, a plurality of retaining notches horizontally arranged in a line at an opposing top side thereof and a wire entry defined in a front side of each said retaining notch corresponding to one respective said wire groove, the wire entries of each said wire-organizer bracket defining different widths.

5. The storing and charging apparatus as claimed in claim 1, wherein said housing further comprises a plurality of connection ports installed in said partition panel at different elevations for the connection of storage mobile electronic devices electrically, a power switch mounted in one outside wall thereof for power on/off control, a power socket disposed adjacent to said power switch for connecting to an external power source by a power cable and a connection module mounted in another outside wall thereof, said connection module comprising at least one electrical connector.

6. The storing and charging apparatus as claimed in claim 1, wherein said housing further comprises a plurality of mating mounting grooves and mounting ribs symmetrically located at opposing top and bottom sides thereof, a plurality of hanging holes located at a back side thereof.

7. The storing and charging apparatus as claimed in claim 1, wherein said front bar of said sliding door comprises two coupling rods respectively extended from two distal ends thereof and respectively slidably coupled to said U-shaped sliding tracks of said housing, two sloping guide surfaces respectively disposed at the two distal ends at a front side relative to said coupling rods, at least one pivot member located at a rear side thereof and a grip; each said sliding door slat comprises a flexible slat body slidably coupled between said U-shaped sliding tracks of said housing, a plurality of slat components extended from said flexible slat body and defining therein an open-ended space, at least one pivot member, and at least one knuckle member, the at least one knuckle member of each said sliding door slat being pivotally coupled to the at least one pivot member of said front bar or the at least one pivot member of another said sliding door slat.

8. The storing and charging apparatus as claimed in claim 1, wherein said housing further comprises an internal electric fan mounted in said power module inside said housing and adapted for expelling hot air from the inside of said housing to the surroundings, an external electric fan mounted in an outside wall of said housing at a rear side relative to said power module and aimed at said first electric fan, and a plurality of ventilation holes disposed corresponding to said external electric fan.

9. The storing and charging apparatus as claimed in claim 1, wherein said housing further comprises a wheel set detachably mounted at a bottom wall thereof, said wheel set comprising at least three mounting plates respectively affixed to the bottom wall of said housing by screws, a wheel bracket mounted in each said mounting plate, and a wheel pivotally mounted in each said wheel bracket.

10. The storing and charging apparatus as claimed in claim 1, wherein said housing further comprises a plurality of ventilation holes located at two opposite lateral walls thereof; each said storage rack comprises a plurality of ventilation holes located at two opposite lateral walls thereof.
